(19) United States
(12) Patent Application Publication
(10) Pub. No.: US 2016/0269793 A1
(43) Pub. Date: Sep. 15, 2016

(54) INTERACTIVE CONTENT DELIVERY SERVICE HAVING FAVORITE PROGRAM SELECTION CAPABILITY

(71) Applicants: Daniel Myers, San Diego, CA (US); Benjamin Ackerman, Los Angeles, CA (US); Amit Nag, New York, NY (US)

(72) Inventors: Daniel Myers, San Diego, CA (US); Benjamin Ackerman, Los Angeles, CA (US); Amit Nag, New York, NY (US)

(73) Assignees: Sony Corporation, Tokyo (JP); Sony Network Entertainment International LLC, Los Angeles, CA (US)

(21) Appl. No.: 15/061,764

(22) Filed: Mar. 4, 2016

Related U.S. Application Data
(60) Provisional application No. 62/132,317, filed on Mar. 12, 2015.

(51) Int. Cl. H04N 21/482; H04N 21/475

(52) U.S. Cl. CPC H04N 21/4826; H04N 21/4828; H04N 21/4755

(57) ABSTRACT

Methods and systems enhance user experience of an interactive content delivery service. A main interface screen comprises a background, playing selected streamed content; and a foreground overlay, comprising a vertical bar crossing a horizontal bar. The vertical bar lists content categories, a first category corresponding to content currently available for immediate viewing, and another category corresponding to content designated by the user as favorite content. The horizontal bar comprises thumbnail representations of content in the category selected by the user from the vertical bar. When the first category is selected, a thumbnail representation in the horizontal bar corresponding to the content currently being played includes a first symbol indicating whether the content being played is live or recorded, and a second symbol indicating whether the content is currently being recorded. When the favorite content category in the vertical bar is selected, a favorites button appears in the foreground overlay.

### CROSS REFERENCES TO RELATED APPLICATIONS

This application claims priority from U.S. Provisional Patent Application Ser. No. 62/132,317, entitled PS Vue: Add to My Favorites, filed on Mar. 12, 2015, which is hereby incorporated by reference as if set forth in full in this application for all purposes.

This application is related to U.S. patent application Ser. No. 14/938,799 entitled “INTERACTIVE CLOUD BASED CONTENT DELIVERY SERVICE” filed on Nov. 11, 2015, which is hereby incorporated by reference as if set forth in full in this application for all purposes.

### BACKGROUND

Cable and satellite providers have control over significant amounts of content (e.g. movies, televisions shows, entertainment specials) that they provide to their customers. Any given pay or subscription package typically includes many providers, channels and shows that the customer is either not interested in at all, or may only want to watch infrequently, as well as just one or a few channels that show content (e.g. episodes of regularly scheduled TV shows) that a given customer may be particularly interested in viewing regularly. Current content delivery services generally require the user to engage in a sequence of several steps in order to record episodes of such shows while they are playing, or to schedule the automatic recording of such episodes in the future. These requirements usually make the customer experience with the particular service less than optimal.

There is therefore a need for improved systems and methods within an interactive content delivery service that allow the customer to select specific programs for recording with a minimum number of actions. Providing the customer with simple and intuitive ways to schedule the recording of one or multiple episodes of a favorite show, to select which of a number of previously recorded episodes of a favorite show to watch at a given time, and even to de-select shows for recording, each with a minimum number of steps would also be advantageous, significantly increasing user satisfaction with the service.

### SUMMARY

Embodiments of the present invention generally relate to methods, systems and user interfaces for enhancing the experience of a user of an interactive content delivery service. In one embodiment, the method comprises displaying a main interface screen on a display viewed by the user, the main interface screen comprising a background, playing selected content that is streamed to the user by the service; and a foreground overlay, comprising a timeline-based cross information bar comprising a vertical bar and a horizontal bar. The vertical bar comprises a scrollable listing of content categories, one content category being a first category corresponding to content currently available for immediate viewing, and another content category being a favorite content category, corresponding to content designated by the user as favorite content. The horizontal bar comprises thumbnail representations of content viewable by the user in the category selected by the user from the vertical bar. In this embodiment, when the first category in the vertical bar is selected, a thumbnail representation in the horizontal bar corresponding to the content currently being played in the background includes a first symbol indicative of whether the content being played is live or recorded, and a second symbol indicative of whether the content is currently being recorded. When the favorite content category in the vertical bar is selected, a favorites button appears in the foreground overlay.

In one aspect, if the favorite content category is selected, and if the user selects the favorites button, and if the content currently being viewed is not in the favorite content category, the content currently being viewed is added to the favorite content category.

A further understanding of the nature and the advantages of particular embodiments disclosed herein may be realized by reference of the remaining portions of the specification and the attached drawings.

### BRIEF DESCRIPTION OF THE DRAWINGS

FIG. 1 is a schematic block diagram of the content delivery service incorporating the favorite program selection feature according to one embodiment;

FIG. 2 is a representation of the main interface screen according to one embodiment;

FIG. 3 is a representation of the main interface screen according to one embodiment;

FIG. 4 is a representation of a secondary interface screen 400 according to one embodiment;

FIG. 5 is a representation of a secondary interface screen 500 according to one embodiment;

FIG. 6. is a representation of a secondary interface screen 600 according to one embodiment;

FIG. 7 is a representation of a media player interface screen 700 according to one embodiment.

### DETAILED DESCRIPTION OF EMBODIMENTS

Embodiments described herein enable a user to quickly and easily interact with a media content delivery system, which provides streaming content based on user selection and preferences. Embodiments generally relate to providing on a display screen of a television, a game console, a set top box, a mobile device, for example, a tablet or smart phone, or similar electronic device, interface screens through which actions designating particular shows or channels (providing particular content) as favorites so that they can be more readily accessed in future, and/or automatically recorded for viewing at times other than the original broadcast or streaming time may be carried out with ease and efficiency. Examples of typical content for viewing on the display screen include traditional TV network, cable, and podcast shows streamed online.

The main issue addressed by embodiments of the present invention is the time-consuming inconvenience affecting a content delivery service user or subscriber, who may be required to navigate through long sequences of selections each time a content choice is made, even though the choice is one that is routinely made, for example to watch the latest episode of one of the subscriber's favorite TV shows, regularly shown on a particular TV channel. The current invention offers the user quick, simple, and intuitive ways to designate (and then watch at leisure) favorite shows and/or channels, using one or at most two actions.

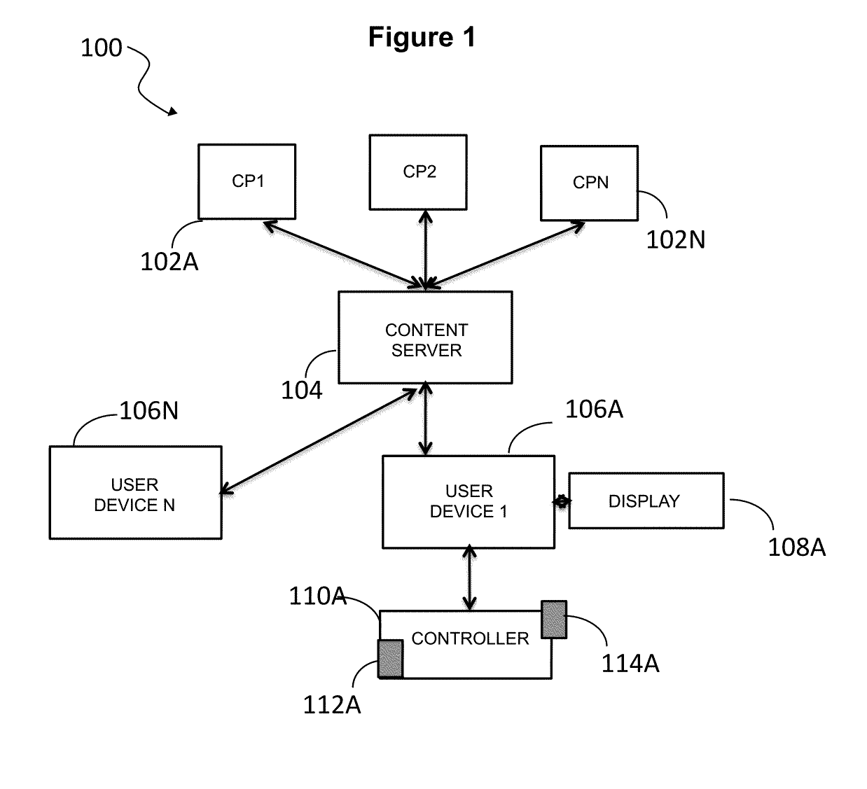

FIG. 1 is a schematic block diagram of an interactive content delivery service according to the present invention. Content providers 102A-102N, for example, cable, satellite and network providers, provide their respective content, for example, television programs, movies, etc. to a content server 104 for distribution to downstream user devices 106A-106N. User device 106A may be implemented as a game console, set top box, laptop, desktop, Blu-ray player, tablet, smart phone or other suitable device capable of executing applications and connecting to and transmitting information over a network. A display device 108A may be integrated within the user device 106A or may be a separate device providing a second screen. In some embodiments, display device 108A may split a single screen into two halves, for example a top screen and a bottom screen, where a top portion of an object (or scene) is shown on the top screen and a bottom portion of an object (or scene) is shown on the bottom screen.

A controller 110A, for example, a G-Shock controller for use with a PlayStation 4 Game Console, is used to make the program selections of the present invention as well as to control other service functions being executed on the user device 106A. In exemplary embodiments, a select button (e.g. X) 112A or a control button (e.g. R1) 114A is used to make the favorite program selections according to the present invention.

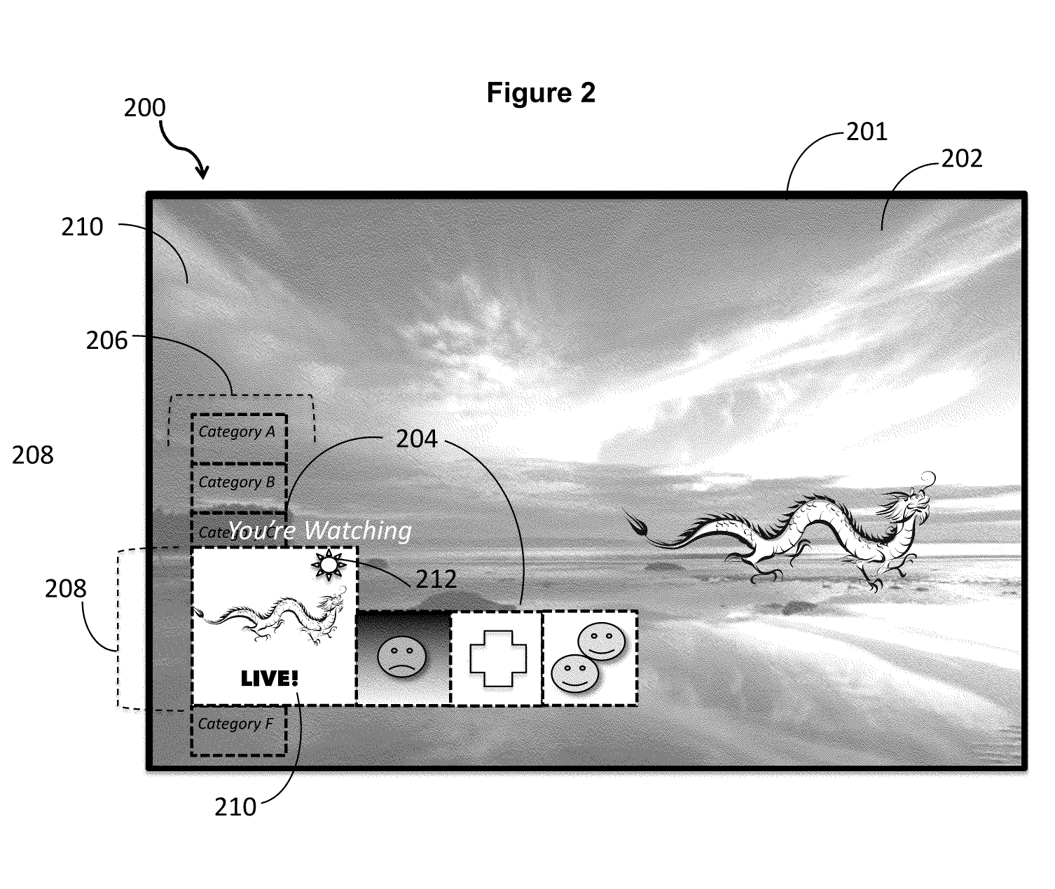

FIG. 2 is a representation of the main interface screen 200 of display device 108A according to one embodiment of the present invention comprising a user interface. The user interface is described in greater detail in co-pending U.S. application Ser. No. 14/938,799, which is incorporated by reference in its entirety herein as noted above. The features of particular relevance to the present invention include a background 202, extending across the full width and height of the display 201, on which selected content is played, and a foreground overlay 204, comprising a timeline-based cross information bar 206, 208. Cross-information bar 206, 208 includes program categories (e.g. You're Watching, My Shows, Favorite Channels etc) on a vertical axis 206; and thumbnails of content viewable within the aforementioned categories listed in time of presentation order along the horizontal axis 208. In some embodiments, if one of the thumbnails corresponds to the content item playing in the background, that thumbnail may be shown with an expanded size relative to the other thumbnails.

The titles give to the categories in vertical bar 206 may be chosen or changed as desired, in any way that serves to represent the type of shows in a way that is easy to understand. For example, the category “My Shows” may instead be titled as “My Favorite Shows” or “Favorites Shows” etc; “You're Watching” may be changed to “On Now” etc as applicable to a given implementation.

In the case illustrated in FIG. 2, the user has selected the “You're Watching” category, listing shows available for immediate watching, and has selected one of the shows listed in response on the horizontal bar 208, so that that particular show is playing in the background of the display. The thumbnail of the episode, including graphical and/or textual information related to the particular episode, is present in the foreground overlay 204 with one indication 210 (e.g. the text “LIVE!” displayed across the lower part of the thumbnail) that the program is being watched during its normal scheduled time slot and another indication 212 showing whether or not the show is being recorded by user device 106A, so that it will be available for future viewing. Indication 212 may, for example, be an icon that only appears if the show is being recorded, or an icon that is always present by flashes only if the show is being recorded.

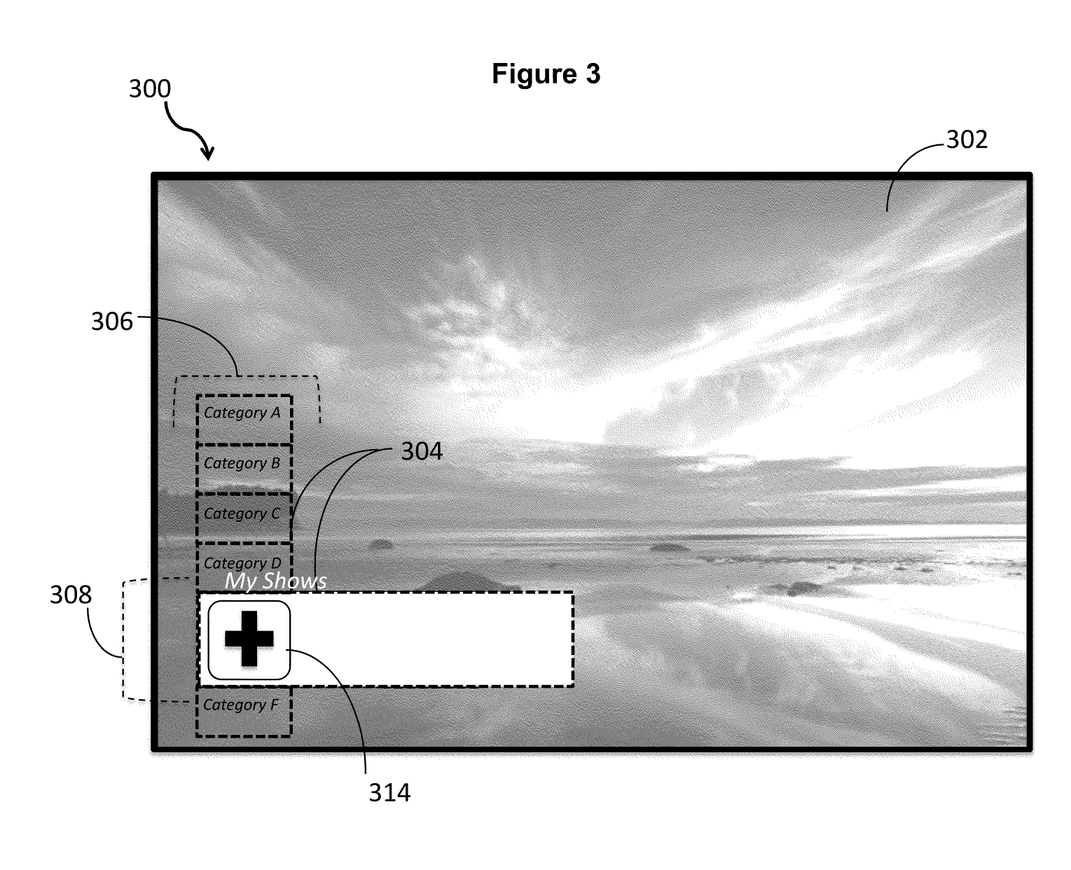

FIG. 3 is a representation of the main interface screen 300 according to one embodiment of the present invention comprising a user interface corresponding to that discussed above with respect to FIG. 2, but depicting the situation where the user has selected a particular category from cross bar 306, 308 from foreground overlay 304, which lists shows that the user has designated as favorites. In the particular case shown, this category has the title “My Shows”, but assuming that no shows have previously been designated as favorites, there are no corresponding thumbnails to display in horizontal bar 308. However, an icon or button 314 is shown, providing the user with the option to designate the show currently playing in background 302 as a favorite. The favorite icon or button 314 is typically shown as including a “+” sign or a “♡” symbol, but any other symbols may be used that would be understood to indicate the user's interest, or preference.

In response to the user selecting the favorites button 314, the show playing in background 302 is added to a list of favorite shows for the user. One consequence of this addition is that in subsequent selections of the “My Shows” category, a thumbnail representing that show will appear in horizontal bar 308. Selecting that thumbnail will then result in the playing of that show in background 302, replaying whatever was playing there prior to that selection. Another consequence of the addition that may occur in some embodiments is that the show playing in background 302 will automatically be recorded, so that it will be available for the user to view at a future time, if and when desired. In some embodiments, if the content is a single episode of a series, another consequence of the addition of the show to the list of favorites is that future episodes of the series will automatically be recorded and made available for subsequent viewing. Such scheduled recordings are typically made for a predetermined time period, for example for 28 days following the user's selection of favorite button 314.

In some embodiments, when a particular show has been added to the user's favorites list and subsequent episodes are recorded, a later selection by the user of the “My Favorite Shows” or equivalent category results in the display of one thumbnail representation in the horizontal bar of the foreground overlay in the main interface screen for each of the recorded episodes.

In some embodiments, selecting favorites button 314 while a show that was previously designated as a favorite will have the opposite effect, that of removing that show from the favorites list.

The selection of favorites button 314 may be accomplished by the user moving an active cursor on display screen 300 to the “+” sign and pressing select button 112A on controller 110A, as shown in FIG. 1. Alternatively, the selection may be accomplished by the user simply pressing hot button 114A on controller 110A while the show is playing in background 302. In either case, just one or at most two actions by the user are sufficient to add the show currently being watched to the user's favorites list, involving minimum interruption of the user's viewing, while allowing several desired, consequential actions to occur. This simplicity is anticipated to significantly enhance the user experience of the content delivery service.

The interactive content delivery service may offer the user many other ways to find and select shows beyond the use of such categories as “You're Watching” and “My Favorite Shows”, as described in detail in co-pending U.S. application Ser. No. 14/938,799, mentioned above. One such option involves the user activating a Search function, where the results may be shown as a tiled display or some other form of listing on a secondary interface screen that replaces main interface screen 200 or 300. Another such option involves the user selecting a channel page from a particular content provider, where programs aired on that channel may be displayed, again on a secondary interface screen. In these cases, a favorite icon may appear in response to the user selecting any one of the displayed results, allowing the user to designate the selected show as a favorite, with the same consequences discussed above—adding that show to a listing of favorites, showing that show when the favorites category is selected from the vertical bar of the cross bar overlay on the main interface screen, automatically recording that show and future episodes, etc. Another such option involves the user depressing a particular information (e.g. “▪”) button on the controller 110A, which causes information describing the content being presented in the background 302 to be displayed in the foreground 304, including a favorites button which may be used to categorize the content as a favorite.

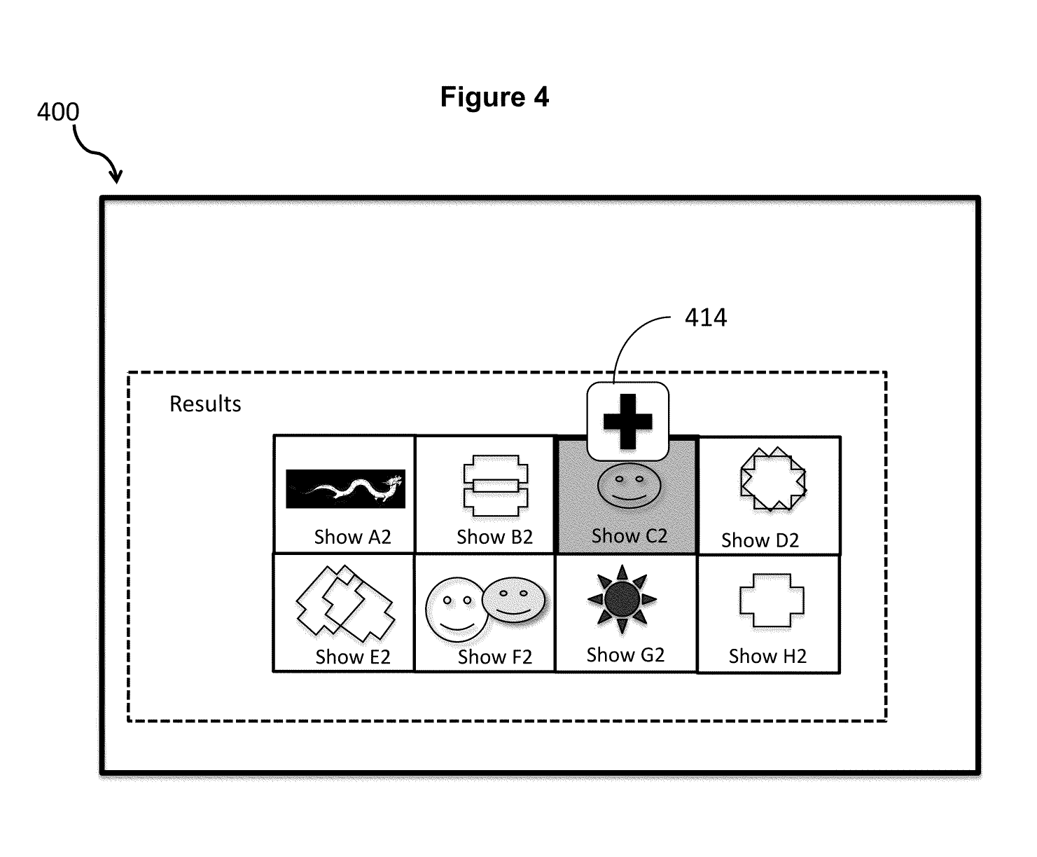

FIG. 4 is a representation of a secondary interface screen 400 according to one embodiment of the present invention that shows the display of favorite icon 414 in one such situation, where the user has selected “Show C2” from a results page following a search, and is offered the option of designating that show as a favorite by selecting icon 414, using controller 110A as described above.

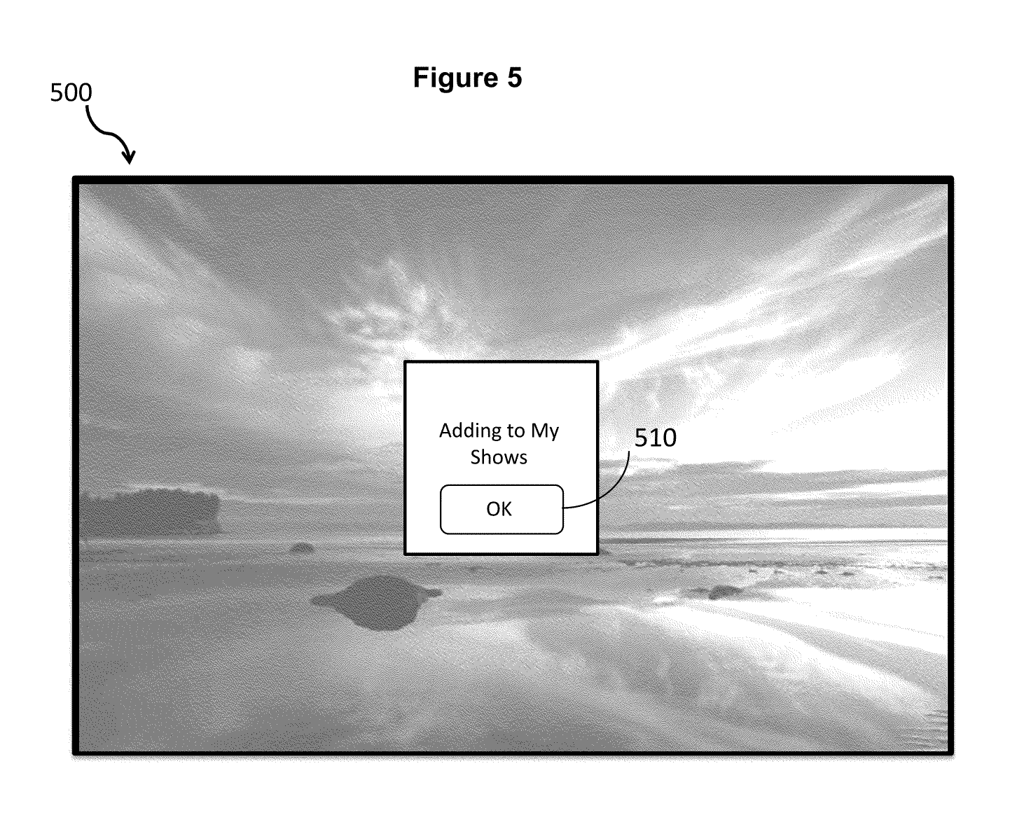

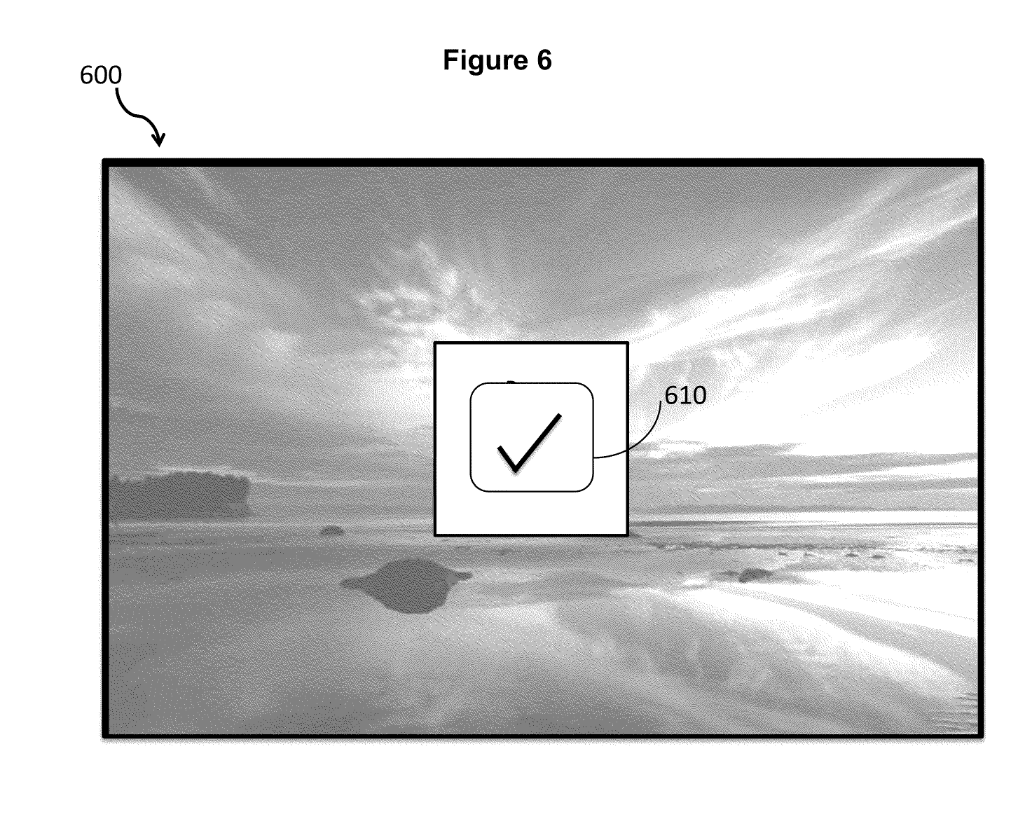

FIGS. 5 and 6 are representations of other interface screens 500 and 600 that may appear in response to the user selecting favorite icon 414 (using select or hot buttons on an external controller as described previously). Screen 500 offers the user the chance to confirm the selection of the corresponding show as a favorite, and if the user agrees by selecting the confirmation button 510, screen 600 shows indication 610, which may be a graphical symbol as shown or text, confirming to the user that the selected program has indeed been added to the user's list of favorites. Additional information may also be displayed in screen 600, explaining, for example, whether the current episode will be recorded, whether future episodes will be recorded, and if so, for how long.

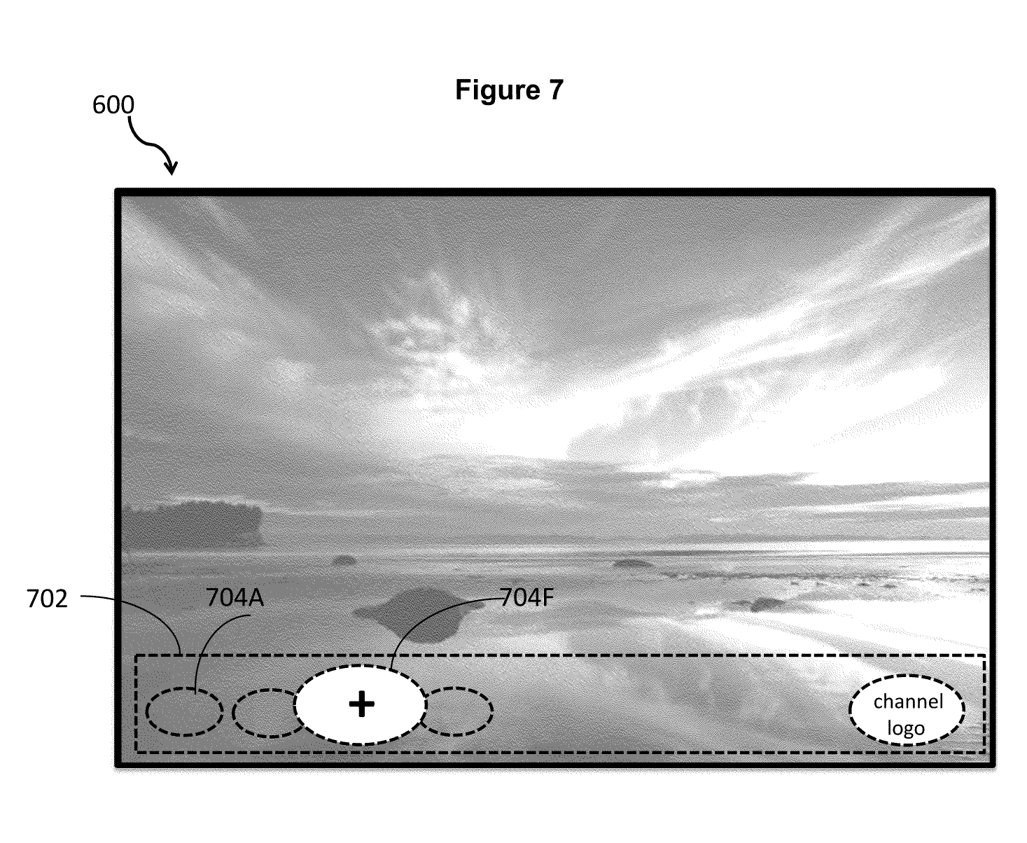

As described in co-pending U.S. application Ser. No. 14/938,799, mentioned above, when the user selects a particular program from the main interface screen 200, 300, or from a secondary interface screen such as a Search interface screen, an Explore interface screen, or a Gallery display view screen, the corresponding content is streamed from a content server to a corresponding media player or user device (such as a television, game playing console etc 106A) for presentation on the corresponding display, 108A. The display presents a media player interface screen 700, as shown in FIG. 7. Media player interface screen 700 includes a media player menu 702, including several functional buttons 704 thereon. The functional button of particular interest to the current invention is the “add” or favorites button 704F, typically indicated with either a “♡” symbol or a “+” sign. When the user depresses or otherwise selects button 704F, button 704F may increase in size or may be highlighted or may be repositioned to a more prominent position (or any combination of the above) as an indication that the content currently being watched has been selected for addition to the user's favorites list. Screen displays such as those described above with respect to FIG. 5 and FIG. 6 may be shown after button 704F is selected to request confirmation of selection of the program to be added to the user's favorites list, and, if confirmation is received, to acknowledge that confirmation. Additional information may also be displayed, explaining, for example, whether the current episode will be recorded, whether future episodes will be recorded, and if so, for how long.

In some embodiments, selecting the favorites button 704F button while a show that was previously designated as a favorite will have the opposite effect, that of removing the show from the favorites list.

Embodiments described herein provide various benefits to the user of a content delivery service. In particular, embodiments enable a user to quickly and easily designate a show as a favorite, and enjoy various corresponding benefits in consequence, such as being able to record that show without further actions being necessary, or being able to easily access that particular episode or other related episodes of the same show in the future. Embodiments allow such designation to be carried out from any of several different interface screens that the user may be presented with during the course of interacting with the content delivery service, even while viewing and enjoying content being played. Embodiments also allow the designation as a favorite to be easily undone, if and when desired. These benefits may be especially valuable to users with access to large volumes of content, through multiple channel providers, but who are primarily interested in a relatively small number of frequently watched shows.

Although the description has been described with respect to particular embodiments thereof, these particular embodiments are merely illustrative, and not restrictive.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments. For example, a tangible medium such as a hardware storage device can be used to store the control logic, which can include executable instructions.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

A “processor” includes any suitable hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems. Examples of processing systems can include servers, clients, end user devices, routers, switches, networked storage, etc. A computer may be any processor in communication with a memory. The memory may be any suitable processor-readable storage medium, such as random-access memory (RAM), read-only memory (ROM), magnetic or optical disk, or other tangible media suitable for storing instructions for execution by the processor.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

1. A method for enhancing the experience of a user of an interactive content delivery service; the method comprising:
displaying a main interface screen on a display viewed by the user, the main interface screen comprising:
a background, playing selected content streamed to the user by the service; and
a foreground overlay, comprising a timeline-based cross information bar comprising a vertical bar and a horizontal bar;
wherein the vertical bar comprises a scrollable listing of content categories, one content category being a first category corresponding to content currently available for immediate viewing, and another content category being a favorite content category, corresponding to content designated by the user as favorite content; and
wherein the horizontal bar comprises thumbnail representations of content viewable by the user in the category selected by the user from the vertical bar;
such that when the first category in the vertical bar is selected, a thumbnail representation in the horizontal bar corresponding to the content currently being played in the background includes a first symbol indicative of whether the content being played is live or recorded, and a second symbol indicative of whether the content is currently being recorded; and
such that when the favorite content category in the vertical bar is selected, a favorites button appears in the foreground overlay.

2. The method of claim 1, wherein if the favorite content category is selected, and if the user selects the favorites button, and if the content currently being viewed is not in the favorite content category, the content currently being viewed is added to the favorite content category.

3. The method of claim 2, wherein in response to the addition of the content to the favorite content category, the content is recorded, and made available for future viewing.

4. The method of claim 3, wherein in response to the addition of the content to the favorite content category, if the content is a single episode of a series, future episodes of the series are recorded and made available for subsequent viewing.

5. The method of claim 3 wherein the recorded content is made available for a period of up to 28 days following the corresponding recording.

6. The method of claim 2, wherein the selection of the favorites button is accomplished by pressing a select button on a controller while an active cursor on the display screen is positioned at the favorites button.

7. The method of claim 2, wherein the selection of the favorites button is accomplished by pressing a hot button on a controller while an active cursor on the display screen is positioned at the favorites button while an active cursor on the display screen is positioned at the favorites button.

8. The method of claim 1, wherein if the favorite content category is selected, and if the user selects the favorites button, and if the content currently being viewed is already in the favorite content category, removing the content currently being viewed from the favorite content category.

9. The method of claim 8, wherein the selection of the favorites button is accomplished by pressing a select button on a controller while an active cursor on the display screen is positioned at the favorites button.

10. The method of claim 8, wherein the selection of the favorites button is accomplished by pressing a hot button on a controller while an active cursor on the display screen is positioned at the favorites button.

11. The method of claim 1, further comprising providing a user option to search or browse available content using one or more interface screens, wherein a favorites button is displayed in conjunction with a result of the search or browsing, such that if the user selects the favorites button, the content corresponding to the result is added to the favorite content category.

12. The method of claim 11, wherein in response to the addition of the content to the favorite content category, the content is recorded, and made available for future viewing.

13. The method of claim 12, wherein in response to the addition of the content to the favorite content category, if the content is a single episode of a series, future episodes of the series are recorded and made available for subsequent viewing.

14. The method of claim 11, further comprising displaying a confirmation screen to the user in response to the selection of the favorites button, requiring the user to confirm the selection.

15. The method of claim 1, further comprising, in response to the selection by the user of an item of content, displaying a media player interface screen, the media player interface screen comprising:
a background reaching the boundaries of the display and playing the selected content;
a favorites button on a foreground overlay, such that if the user selects the favorites button, and if the content currently being viewed is not in the favorite content category, the content currently being viewed is added to the favorite content category.

16. The method of claim 15, wherein in response to the addition of the content to the favorite content category, the content is recorded, and made available for future viewing.

17. The method of claim 16, wherein in response to the addition of the content to the favorite content category, if the content is a single episode of a series, future episodes of the series are recorded and made available for subsequent viewing.

18. The method of claim 15, wherein the selection of the favorites button is accomplished either by pressing a select button on a controller or by pressing a hot button on a controller while an active cursor on the display screen is positioned at the favorites button.

19. An apparatus comprising:
one or more processors; and
logic encoded in one or more non-transitory tangible media for execution by the one or more processors and when executed operable to enhance the experience of a user of an interactive content delivery service by:
displaying a main interface screen on a display viewed by the user, the main interface screen comprising:
a background, playing selected service-delivered content; and
a foreground overlay, comprising a timeline-based cross information bar comprising a vertical bar and a horizontal bar;
wherein the vertical bar comprises a scrollable listing of content categories, one content category being a first category corresponding to content currently available for viewing, and another content category being a favorite content category, corresponding to content designated by the user as favorite content; and
wherein the horizontal bar comprises thumbnail representations of content viewable by the user in the category selected by the user from the vertical bar;
such that when the first category in the vertical bar is selected, a thumbnail representation in the horizontal bar corresponding to the content currently being played in the background includes a first symbol indicative of whether the content being played is live or recorded, and a second symbol indicative of whether the content is currently being recorded; and
such that when the favorite content category in the vertical bar is selected, a favorites button appears in the foreground overlay.

20. The method of claim 4 wherein the recorded content is made available for a period of up to 28 days following the corresponding recording.
